(19) United States
(12) Patent Application Publication
(10) Pub. No.: US 2006/0188754 A1
(43) Pub. Date: Aug. 24, 2006

(54) Steel-on-steel and compliant-on-steel calendered magnetic recording media, and methods of making

(76) Inventors: David C. Lowery, Roberts, WI (US); Mark D. Larson, Maplewood, MN (US); Stephen R. Ebner, Stillwater, MN (US); Ryosuke Isobe, Superior, CO (US); Guy Tadlock, Auburn, AL (US)

Correspondence Address: IMATION CORP., P.O. BOX 64898, ST. PAUL, MN, 55164-0898, US

(21) Appl. No.: 11/408,743

(22) Filed: Apr. 21, 2006

Related U.S. Application Data
(63) Continuation of application No. 10/393,416, filed on Mar. 20, 2003.
(60) Provisional application No. 60/415,354, filed on Oct. 1, 2002.

(51) Int. Cl. G11B 5/716; B05D 5/12

(52) U.S. Cl. 428/840; 427/127

(57) ABSTRACT

A method for producing a magnetic recording medium includes applying a non-magnetic back coat to a substrate, applying a magnetic front coat to the substrate, in-line calendering the coated substrate using opposed rolls, at least one of the rolls being a generally compliant roll, and off-line calendering the substrate using opposed, generally non-compliant rolls. The off-line calendering optionally includes steel-on-steel calendering and the method optionally includes only one off-line calendering pass and only one in-line calendering pass. Calendering the coated substrate optionally occurs using at least one nip, the calendering including calendering the coated substrate through a final nip including generally non-compliant rolls. Other methods, and magnetic recording media produced by such methods, also are disclosed.

### CROSS-REFERENCE TO RELATED APPLICATION

This is a continuation application claiming priority under 35 U.S.C. § 120 to U.S. patent application Ser. No. 10/393,416, entitled “STEEL-ON-STEEL AND COMPLIANT-ON-STEEL CALENDERED MAGNETIC RECORDING MEDIA, AND METHODS OF MAKING” filed Mar. 20, 2003, which claims priority under 35 U.S.C. § 119(e) to U.S. Provisional Patent Application No. 60/415,354, filed Oct. 1, 2002, the contents of both of those applications being incorporated herein by reference.

### BACKGROUND OF THE INVENTION

Magnetic recording media, such as data cartridge tapes, videotapes, audio tapes, other magnetic recording tapes, floppy discs, etc., enjoy wide use and popularity. Such media have evolved to provide increased recording density or capacity per unit volume, reduced average surface roughness and surface-roughness variability, reduced electromagnetic amplitude degradation caused by roughness and other factors, and increased reliability, as measured by e.g., read and write error rate increases over extended periods of use. It is known in the art to calender the media during its manufacture, e.g., to pass it through a series of opposed rollers before winding it into a roll, to improve surface smoothness.

Magnetic recording media generally include a magnetic layer coated onto at least one side of a non-magnetic substrate, e.g., a film in the case of magnetic recording tape applications. The magnetic layer includes magnetic pigment dispersed in a polymeric binder. The magnetic layer also optionally includes other components, such as lubricants, abrasives, thermal stabilizers, catalysts, crosslinkers, antioxidants, dispersants, wetting agents, fungicides, bactericides, surfactants, antistatic agents, nonmagnetic pigments, coating aids, and the like. A backside coating is applied to the other side of the non-magnetic substrate, e.g., to improve the durability, conductivity, and tracking characteristics of the media. The backside coating also optionally includes a polymeric binder and one or more of the components listed above. In the case of magnetic recording tape, the film or substrate carrying the magnetic layer and the backside coating often is slit to form the tape.

With certain designs, the magnetic coating (or “front coating”) is formed as a single layer. In an effort to reduce thickness of the magnetic recording layer, a more recent approach is to form the front coat in a dual layer construction, including a support layer (or “lower layer”) on the substrate and a reduced-thickness magnetic layer (or “upper layer”) formed directly on the support or lower layer. With this construction, the lower layer is generally non-magnetic and is comprised of a non-magnetic powder and a binder. Conversely, the upper layer comprises a magnetic metal particle powder or pigment dispersed in a polymeric binder.

Linear Tape-Open (LTO) technology seeks to provide open-format, high-performance tape storage products that enhance reliability and versatility in e.g., the network tape storage environment. LTO technology, being open format, provides users with multiple sources of product and media, and enables compatibility between the offerings of different vendors. The ULTRIUM format is a high-capacity implementation of LTO technology. Other technologies are well-established and known in the art, e.g., the Digital Linear Tape series formats including DLT 4000, DLT 7000, and DLT 8000 (also known as DLT4, DLT7, and DLT8) drives and media. Detailed technical descriptions of each of these format generations are available from, e.g., the European Computer Manufacturers Association (ECMA) and the American National Standards Institute (ANSI). DLT magnetic tape cartridges and drives are available on many systems and provide tape backup capability, for example.

### SUMMARY OF THE INVENTION

According to one aspect of the invention, a method for producing a magnetic recording medium includes applying a non-magnetic back coat to a substrate, applying a magnetic front coat to the substrate, in-line calendering the coated substrate using opposed rolls, at least one of the rolls being a generally compliant roll, and off-line calendering the coated substrate using opposed, generally non-compliant rolls. The magnetic front coat optionally is a dual-layer front coat. The method optionally includes only one off-line calendering pass and/or only one in-line calendering pass. The off-line calendering pass optionally occurs after the in-line calendering pass. The in-line calendering optionally includes applying the generally compliant roll to a side of the substrate having the back coat, and additionally also includes applying an additional generally non-compliant roll to a side of the substrate having the front coat. The off-line calendering optionally occurs at a nip pressure of at least about 2200 pounds per linear inch (pli, here and throughout this patent application) and a temperature of at least about 195° F.

According to another particular aspect of the invention, a magnetic recording medium is produced by the above-described method. The magnetic front coat optionally comprises a non-magnetic lower layer and a magnetic upper layer. The magnetic recording medium optionally is in linear magnetic tape format.

According to another particular aspect of the invention, a method for producing a magnetic recording medium includes applying a non-magnetic back coat to a substrate, applying a magnetic front coat to the substrate, and calendering the coated substrate using at least one nip, wherein the calendering includes calendering the coated substrate through a final nip comprising generally non-compliant rolls. The calendering optionally includes in-line calendering using in-line generally compliant rolls followed by in-line generally non-compliant rolls. The calendering also optionally includes off-line calendering using off-line generally compliant rolls followed by off-line generally non-compliant rolls. Further, the calendering optionally includes in-line calendering using in-line generally non-compliant rolls followed by off-line calendering using off-line generally non-compliant rolls. The calendering also optionally includes in-line calendering using in-line generally compliant rolls followed by off-line calendering using off-line generally non-compliant rolls. The magnetic front coat has a thickness of less than about 2.5 microns, and the final nip defines a nip pressure of at least about 700 pli and a roll temperature of at least about 100° F., according to embodiments of the invention.

According to another aspect of the invention, a magnetic recording medium is produced by the above-described method. The magnetic recording medium defines a roughness average (Rₐ) of no more than about 6.3 nm. The magnetic recording medium optionally comprises Digital Linear Tape.

Other features and aspects according to embodiments of the invention will be apparent from the remainder of this disclosure.

### BRIEF DESCRIPTION OF THE DRAWINGS

FIG. 1 is a flow chart schematically illustrating a magnetic recording medium production method, according to an embodiment of the invention;

FIG. 2 is a flow chart schematically illustrating an alternative magnetic recording medium production method, according to an embodiment of the invention;

FIG. 3 is a perspective view of a magnetic recording medium, according to an embodiment of the invention;

FIG. 4 is a plot of cumulative read errors/GB versus elapsed time, according to an embodiment of the invention;

FIG. 5 is a plot of cumulative write errors/MB versus elapsed time, according to an embodiment of the invention;

FIG. 6 is a plot of read errors/GB versus hours, according to an embodiment of the invention;

FIG. 7 is a plot of write errors/MB versus hours, according to an embodiment of the invention;

FIG. 8 is a plot of amplitude parametrics versus calendar conditions, according to an embodiment of the invention;

FIG. 9 is a plot of write errors/MB versus hours, according to an embodiment of the invention;

FIG. 10 is a plot of read errors/GB versus hours, according to an embodiment of the invention; and

FIG. 11 shows statistical analysis of COS versus SOS calendering, according to an embodiment of the invention.

### DETAILED DESCRIPTION OF PREFERRED EMBODIMENTS

Embodiments of the invention apply to a wide variety of magnetic recording media and methods of making such media, such as magnetic tape in LTO format, DLT format, and other formats. Although embodiments of the invention are particularly applicable to magnetic tape and will be described accordingly, the invention should not be considered limited to magnetic tape. Other types of magnetic recording media, e.g., magnetic disks, also are contemplated according to the invention in its various embodiments.

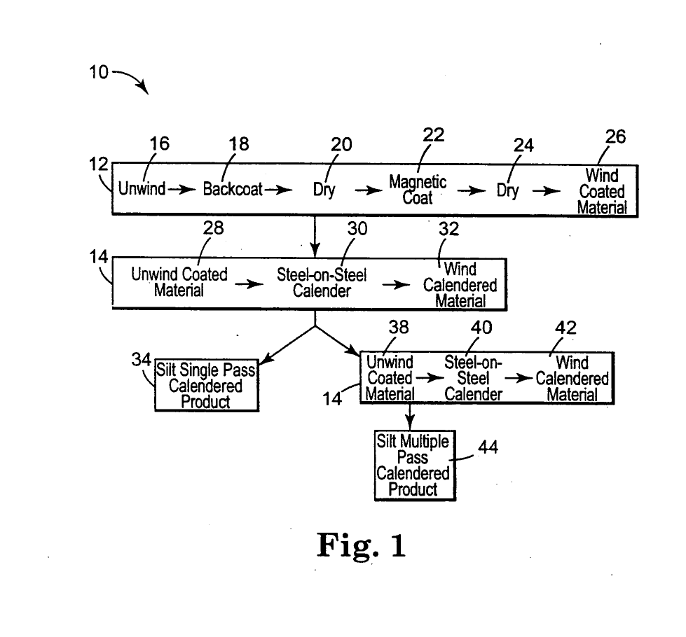

FIG. 1 schematically illustrates original media production process 10, applicable, e.g., to ULTRIUM brand tape products. Process 10 includes in-line portion 12 and one or more off-line portions 14. In-line portion 12, which occurs, e.g., all in the same manufacturing line, includes optionally unwinding, at 16, a non-magnetic substrate or other material from a spool or supply. Back coating of the substrate occurs at 18, during which a backside coating is applied to one side of the substrate. The backside coating optionally includes a polymeric binder and one or more other components to, e.g., improve the durability, conductivity, and tracking characteristics of the media. Drying of the backside coating occurs at 20. A magnetic coating is applied to the substrate, at 22. The magnetic coating is of single-layer, dual-layer, or other construction, and optionally includes magnetic pigment dispersed in a polymeric binder and one or more other components to produce desired properties. Magnetic coating 22 (i.e., front coating) optionally occurs prior to back coating 18. The coated substrate is dried, at 24, and then wound, at 26.

Process 10 then proceeds to off-line portion 14, which occurs off the manufacturing or production line associated with in-line portion 12. Off-line portion 14 optionally occurs at another machine or location, for example. The coated substrate is unwound, at 28, and then is calendered, at 30. Calendering 30 includes passing the coated substrate through a series of generally non-compliant rollers, e.g., multiple steel rollers, and is called a “steel-on-steel” (SOS) calendering process, although materials other than steel optionally are used. The coated, calendered substrate then is wound, at 32.

Process 10 thus far has provided single-pass, off-line calendering. After off-line portion 14, the single-pass calendered product optionally is slit, at 34, to form tape for incorporation into cartridges or for other use. Although acceptable for some purposes, a single-pass off-line calendering process often is considered to yield tape of insufficient magnetic surface smoothness or electromagnetic output level, and/or of insufficient quality in terms of electrical resistance, friction, cupping or curling factors, abrasivity, or other surface factors.

Accordingly, process 10 optionally continues to second off-line portion 14, which includes unwinding 38, SOS calendering 40, and winding 42. Following second off-line processing portion 14, the multiple-pass, off-line calendered product is slit, at 44. Additional off-line calendering or other processing (not shown) also optionally occurs between second off-line portion 14 and slitting 44. Although it potentially improves magnetic surface smoothness and electromagnetic output level or quality, multiple off-line calendering passes place a significant drain on manufacturing productivity. Equipment run-time, associated costs, and product-handing defects such as wrinkles, impressions, embossments and the like, all are potentially increased with multiple-pass, off-line calendering.

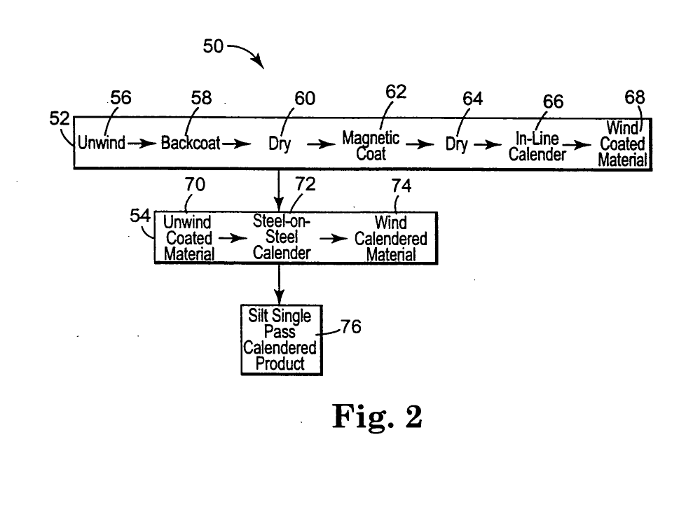

The FIG. 2 embodiment, therefore, potentially avoids multiple off-line calendering passes, in that one calendering pass occurs in-line and one calendering pass occurs off-line. Method 50 for producing a magnetic recording medium includes an in-line portion 52 and an off-line portion 54, e.g., a single off-line portion. After optionally unwinding a substrate or other material 56, a non-magnetic back coat is applied to the substrate, at 58. Drying occurs at 60. A magnetic front coat is applied to the substrate, at 62, and additional drying occurs, at 64. Application of the magnetic front coat 62 optionally occurs prior to application of the non-magnetic back coat 58.

Method 50 additionally includes in-line calendering of the substrate, at 66. According to one embodiment, in-line calendering 66 uses one or more in-line nip stations, in each of which a steel or other generally non-compliant roll contacts or otherwise is applied to the magnetically coated side of the substrate, and a rubberized or other generally compliant roll contacts or otherwise is applied to the backcoated side. The generally non-compliant roll provides a desired degree of smoothness to the magnetically coated side of the substrate. Alternately, the in-line calendering is SOS or otherwise employs one or more nip stations each having generally non-compliant rolls. After in-line calendering 66, the substrate or other material is wound, at 68.

During off-line portion 54 of method 50, the coated substrate is unwound, at 70. Method 50 then includes off-line calendering 72 of the substrate, using one or more nip stations having opposed, generally non-compliant rolls formed of, e.g., steel. Off-line calendering 72 thus optionally is SOS calendering, although COS calendering, using one or more nip stations having at least one generally compliant roll, also is contemplated. Method 50 optionally comprises only one in-line calendering pass, at 66, and only one, subsequent, off-line calendering pass, at 72. Winding occurs at 76. The substrate thus has been calendered more than once, but only once off-line. The single-pass off-line calendered product then is slit, at 76, for incorporation into cartridges or for other use.

Table 1 below shows improvements obtained with the use of in-line calendering in a tape-making process. Relative output is given relative to an ULTRIUM reference tape, large relative errors denote 40% level dropouts (i.e., reflecting a relatively large error in that only 40% of the original signal remains), and small relative errors denote 60% level dropouts (i.e., reflecting a relatively small error such that 60% of the original signal remains).

Example A in Table 1 used a single in-line calendering pass and created higher 60% level dropouts than any of the other examples. All of the examples that used both in-line and off-line calendering had lower errors than the example without in-line processing, Example B. The two-trip off-line example, Example E, showed a higher error level than the single-trip off-line examples, Examples C and D. Of the two single-trip off-line examples, Examples C and D, the example with the higher nip pressure and higher roll temperature, Example D, yielded better relative output and fewer relative errors.

TABLE 1

| | In-Line | Off-Line | Relative | Relative | Relative |
|---|---|---|---|---|---|
| Example | Condition | Condition | Output (dB) | Errors (large) | Errors (small) |
| A | 1900pli/210° F. | None | 0 | 5.4 X | 18.7 Y |
| B | None | 1 Trip | +2.9 | 6.4 X | 11 Y |
| | | 2900pli/180° F. | | | |
| C | 1900pli/200° F. | 1 Trip | +3.1 | 5.4 X | 4 Y |
| | | 1750pli/195° F. | | | |
| D | 1900pli/200° F. | 1 Trip | +3.8 | X | Y |
| | | 2200pli/195° F. | | | |
| E | 1900pli/200° F. | 2 Trips | +4.2 | 2.8 X | 8 Y |
| | | 2900pli/180° F. | | | |

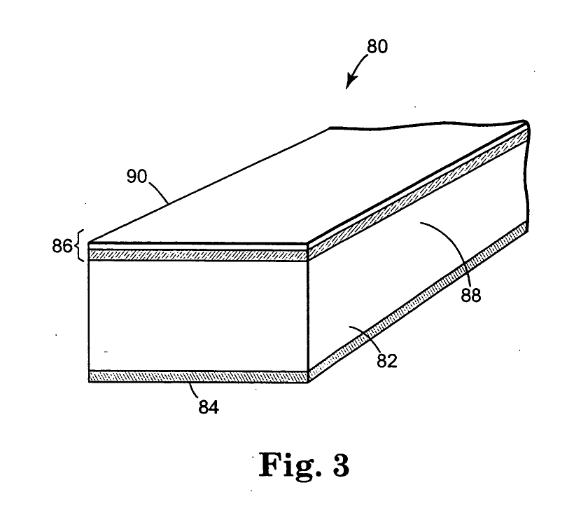

Embodiments of the invention also extend to a magnetic recording medium, for example, linear open-format magnetic tape or other tape, produced by methods described above. As shown in FIG. 3, for example, magnetic recording medium 80 includes non-magnetic substrate 82, backcoat layer or back coat 84, and front coat layer or front coat 86. Front coat 86 optionally includes non-magnetic lower layer 88, which optionally is a soft magnetic lower layer, and magnetic upper layer 90.

Particular aspects of the invention described and illustrated with respect to FIGS. 1-3 provide a number of advantages, including improved tape output over single-pass off-line and single-pass COS in-line calendering processes, improved productivity over a two pass off-line calendering process, reduced risk of error generation resulting from the limited number of calendering passes, reduced product-handling defects, such as wrinkles, impressions, embossments, etc., all of which degrade yield, and/or reduced costs of operating the associated manufacturing equipment.

Other aspects of the invention, useable in connection with the embodiments of FIGS. 1-3 or independently, relate to calendering, e.g., DLT media using generally non-compliant rolls, e.g., all-steel rolls, instead of a combination of steel and compliant rolls (compliant-on-steel or COS calendering). Such calendering results in improved end product, in certain situations. Additionally, improvements are further enhanced, in SOS or other calendering with generally non-compliant rolls, as temperature and nip pressure are increased. Changing from a COS to a SOS process, according to several examples, achieved a marked improvement in smoothness and electromagnetic amplitude. Because of these improvements, reliability was also generally improved. Construing the improvements seen in going from COS to SOS calendering as a trend in compression effectiveness, the trend was extended in several examples by increasing SOS calender roll temperature and nip pressure.

An experiment comparing SOS and COS calendering processes with respect to, e.g., DLT media showed that SOS calendering yielded media having reduced surface roughness and improved electromagnetic amplitude or output. Examples F and G in Table 2 below are for COS and SOS samples, respectively. Z range, Rq, Ra and Kurtosis roughness measures all were lower for SOS calendering than for COS calendering, and 1F, 2F, and 4F electromagnetic amplitude measures, and 2/1 and 4/2 electromagnetic amplitude resolution measures, all were higher.

TABLE 2

| | |
|---|---|
| | DLT4000 Parametrics |
| Magnetic Coating (AFM) | (% of standard) |

| | Calender | Z range | Rq | Ra | | | 1F | 2F | 4F | 2/1 | 4/2 |
|---|---|---|---|---|---|---|---|---|---|---|---|
| Example | Type | (nm) | (nm) | (nm) | Skew | Kurt. | amp | amp | amp | res | res |
| F | COS | 223 | 9.5 | 7.0 | −1.4 | 12.6 | 106.1 | 104.7 | 92.7 | 100.7 | 88.7 |
| G | SOS | 174 | 8.8 | 6.3 | −1.4 | 6.8 | 113.0 | 122.5 | 122.2 | 108.3 | 100.4 |

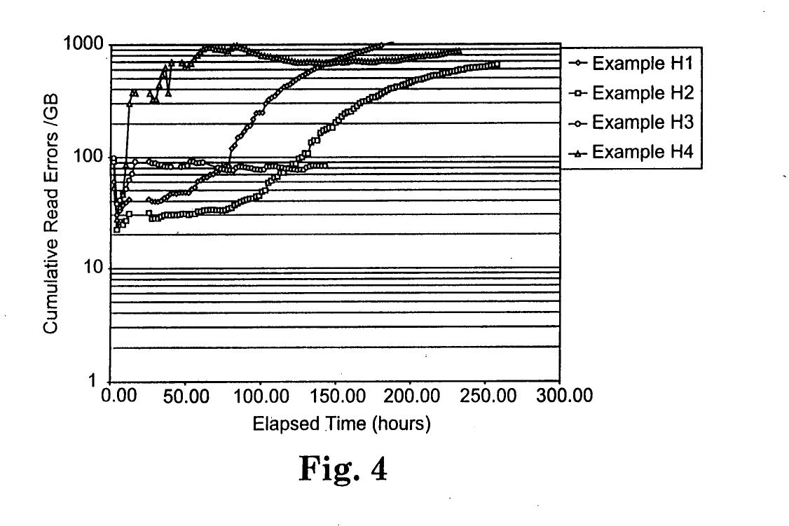

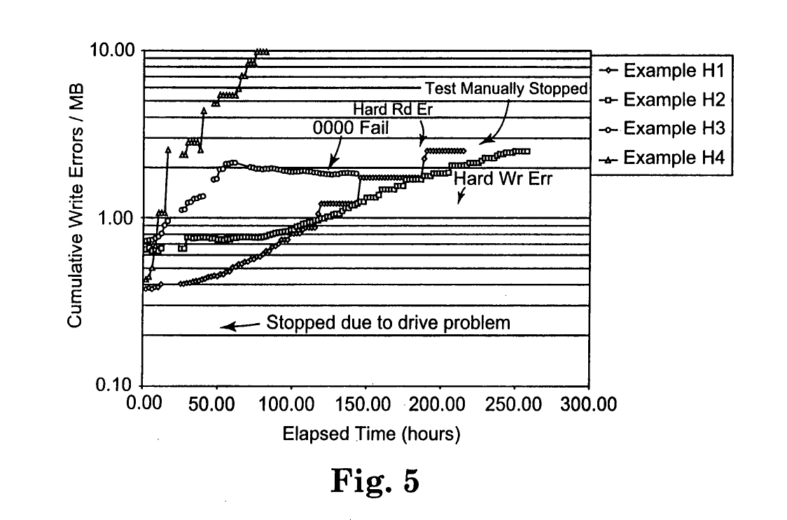

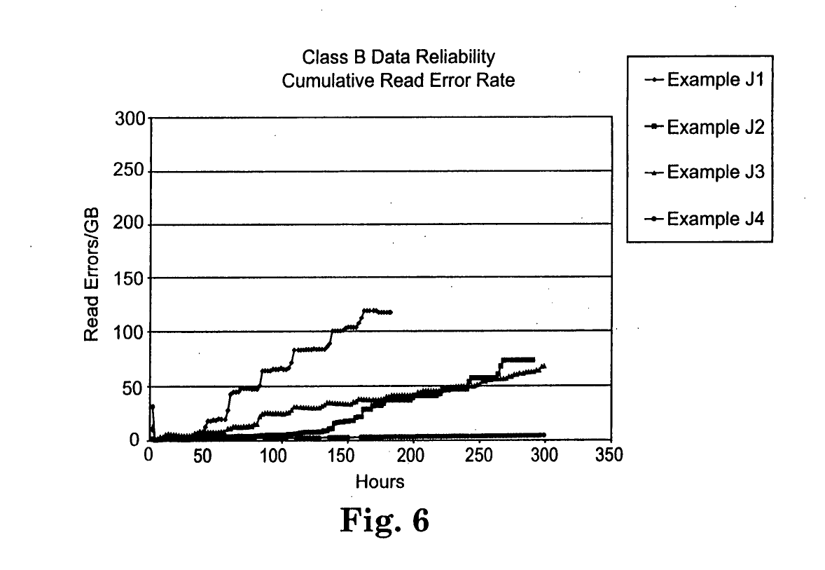

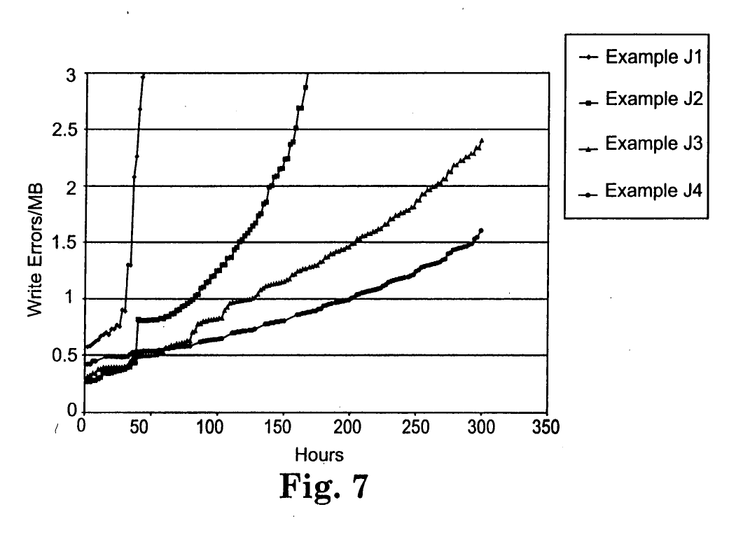

In addition to magnetic surface roughness and electromagnetic amplitude measures, SOS calendering yielded higher reliability than COS calendering. FIGS. 4-7 illustrate reliability results for experiments during which media usage was cycled through varying temperature and pressure conditions per Quantum Corporation's DLT “Class B” environment in a DLT7000 drive (hereafter “Class B reliability”) and error growth rate was measured as a function of time. Examples H1-H4 (FIGS. 4-5) represent COS calendering of DLT4 format tape—specifically two-pass COS, which more closely approaches SOS in terms of Class B reliability. Examples J1-J4 (FIGS. 6-7) represent SOS calendering of DLT4 format tape. More specifically, FIGS. 4-5 illustrate Class B reliability in terms of cumulative read errors/GB and cumulative write errors/MB over time, respectively. FIGS. 6-7 illustrate Class B reliability in terms of read errors/MB and write errors/GB over time, respectively. As indicated by the results, the reliability of the SOS-calendered media examples J1-J4 was better than that of the double-COS-calendered media examples H1-H4, especially for read errors.

Surface roughness measurements described here and elsewhere herein were made using a Digital Instruments atomic force microscope (AFM) operating in contact mode with a Digital Instruments “NP”-type silicon nitride probe having a nominal tip radius of 20-60 nm and a 200 micron cantilever length. The scanned area was 100 microns by 100 microns (10,000 square microns). Data was processed using Digital Instruments software for 3^{rd} order flatten and roughness analysis routines.

Additional experiments extended the improvements seen in going from COS to SOS calendering, by increasing SOS calender roll temperature and nip pressure and measuring resultant amplitudes and reliability. Examples with the prefix “K” in Table 3, below, are associated with three SOS calendering temperature and pressure conditions termed “Low,” “Mid,” and “High” and given corresponding condition codes 1, 2, and 3, as shown.

TABLE 3

| Example | Condition name - code | Roll Temp (° F.) | Nip Pressure (pli) |
|---|---|---|---|
| K-103 | Low - 1 | 105 | 1742 |
| K-104 | Mid - 2 | 145 | 2383 |
| K-203 | Mid - 2 | 145 | 2383 |
| K-204 | High - 3 | 165 | 3105 |

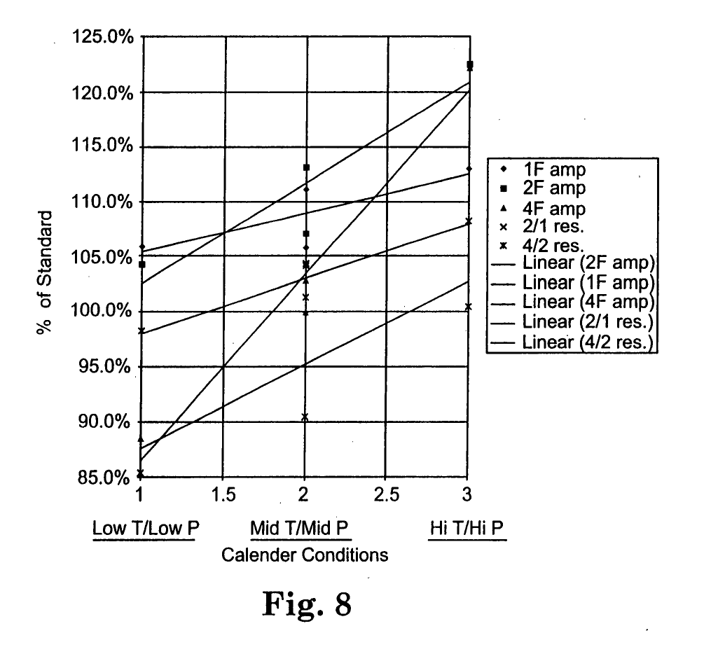

FIG. 8 plots DLT4 amplitude characteristics against the calendering conditions of Table 3. As shown, the percent-of-standard variable increases as calender conditions progress from low to mid to high temperature/pressure. Thus, there is a clear trend toward improved amplitude with increased SOS calender temperature and pressure.

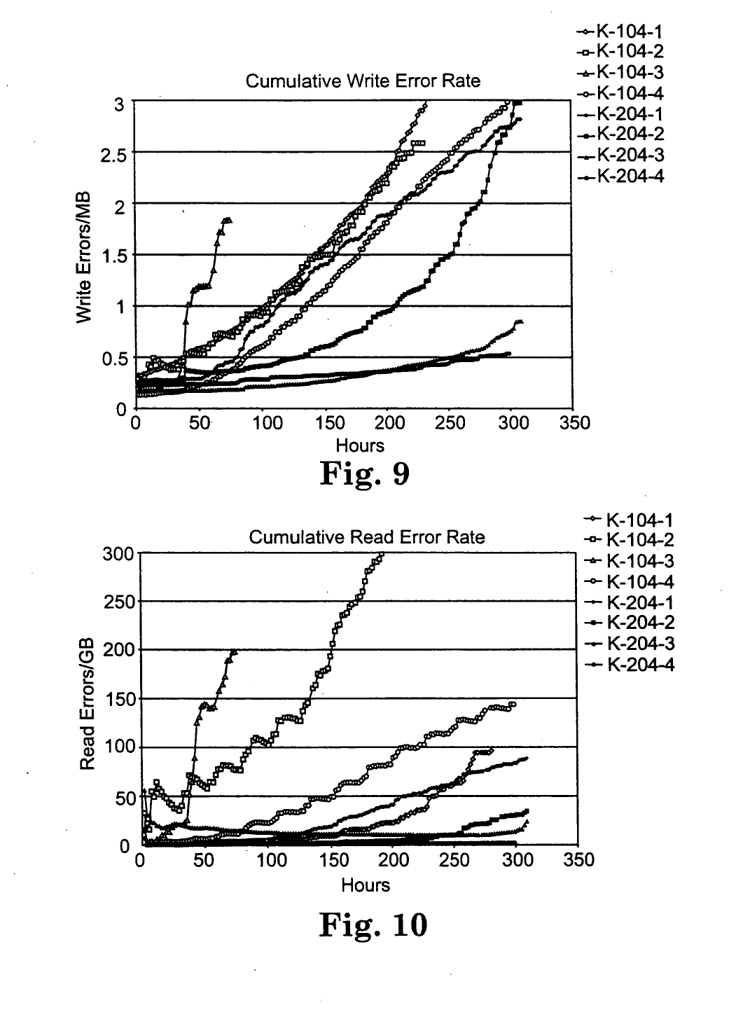

FIGS. 9-10 are reliability data plots that demonstrate a trend toward improved reliability performance with increasing SOS calender temperature and pressure. For example, comparing K-104 series examples (“Mid” temperature and pressure, per Table 3) with K-204 series examples (“High” temperature and pressure, per Table 3) in each of FIGS. 9-10 indicates lower cumulative write error rates (FIG. 9) and read error rates (FIG. 10) over time for the higher temperature and pressure conditions present in the K-204 series examples.

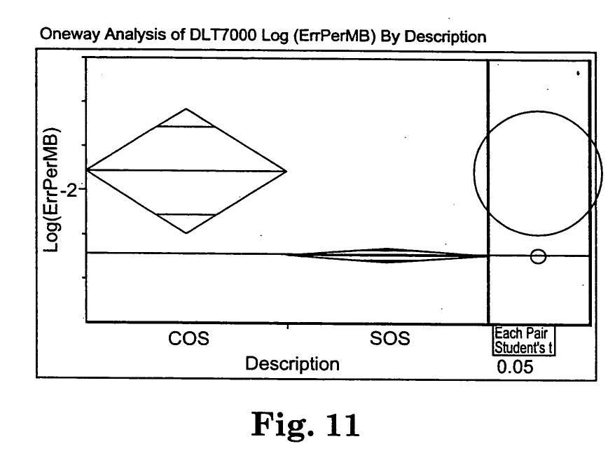

Statistical analysis represented in Table 4 below and in FIG. 11 also demonstrates experimental superiority of a steel-on-steel (SOS) calendering process over a compliant-on-steel (COS) process with respect to initial media error rates, i.e., for new product quality. As shown in FIG. 11, lower errors (or, more precisely, lower Log(Errors)) are recorded for the SOS process. The statistical significance of the differences in error rates is demonstrated by the Student's t test results in FIG. 11 and in the Oneway Anova t Test and Analysis of Variance portions of Table 4.

TABLE 4
Oneway Anova t Test

| | Difference | t Test | DF | Prob > \|t\| |
|---|---|---|---|---|
| Estimate | 0.189713 | 2.613 | 1872 | 0.0090 |
| Std Error | 0.072606 | | | |

Analysis of Variance

| Source | DF | Sum of Squares | Mean Square | F Ratio | Prob > F |
|---|---|---|---|---|---|
| Description | 1 | 0.85272 | 0.852721 | 6.8274 | 0.0090 |
| Error | 1872 | 233.80812 | 0.124898 | | |
| C. Total | 1873 | 234.66085 | | | |

Thus, according to an embodiment of the invention, a method for producing a magnetic recording medium such as medium 80 in FIG. 3 includes applying non-magnetic back coat 84 to substrate 82, applying magnetic front coat 86 to substrate 82, front coat 86 optionally comprising non-magnetic lower layer 88 and magnetic upper layer 90, and calendering the substrate between two generally non-compliant rolls.

According to another embodiment of the invention, a method for producing a magnetic recording medium such as medium 80 in FIG. 3 includes applying a non-magnetic back coat 84 to substrate 82, applying magnetic front coat 86 to substrate 82, and calendering coated substrate 82 using at least one nip, wherein the calendering includes calendering the coated substrate through a final nip, for example the final nip through which the coated substrate passes, comprising generally non-compliant rolls. The calendering optionally includes in-line calendering using in-line generally compliant rolls followed by in-line generally non-compliant rolls. The calendering also optionally includes off-line calendering using off-line generally compliant rolls followed by off-line generally non-compliant rolls. Further, the calendering optionally includes in-line calendering using in-line generally non-compliant rolls followed by off-line calendering using off-line generally non-compliant rolls. The calendering also optionally includes in-line calendering using in-line generally compliant rolls followed by off-line calendering using off-line generally non-compliant rolls. Other permutations of inline and offline calendering each using generally compliant and/or generally non-compliant rolls also are contemplated.

Calendering generally is believed to become more problematic as front coat thickness is reduced. The thinner the front coat, the more difficult it is to accomplish compliant-only calendering. Generally non-compliant calendering according to embodiments of the invention, on the other hand, provides the ability to produce media with reduced coating thicknesses. A magnetic front coat according to embodiments of the invention has a thickness of less than or equal to about 2.5 microns, for example, or a thickness of less than or equal to about 1 micron, about 0.5 micron, or about 0.25 micron.

Substrate 82 optionally is calendered between two generally non-compliant rolls, for example as at 30, 40, and/or 72 in FIGS. 1-2. The generally non-compliant rolls, which optionally constitute the final nip through which the coated substrate is calendered, define a nip pressure of at least about 700 pli and a roll temperature of about 100° F. Alternatively, such nip pressure or other nip pressures herein are about 3000 pli and roll temperature is at least about 150° F. Nip pressure also optionally is in the range of about 2900 pli to about 3300 pli, or about 3050 pli to about 3150 pli, or about 2200 pli to about 3300 pli, or about 700 pli to about 5000 pli, or in ranges with higher or lower boundaries. Roll temperatures herein also optionally are in the range of about 150° F. to about 180° F., or about 160° F. to about 170° F., or about 150° F. to about 225° F., or about 100° F. to about 350° F., or in ranges with higher or lower boundaries. According to additional embodiments, nip pressure is at least about 3100 pli and roll temperature is at least about 160° F. or at least about 165° F.

According to another embodiment, a magnetic recording medium such as medium 80 is produced by a method comprising applying non-magnetic back coat 84 to substrate 82, applying magnetic front coat 86 to substrate 82, front coat 86 comprising non-magnetic lower layer 88 and magnetic upper layer 90, and calendering substrate 82 between two generally non-compliant rolls defining a nip pressure of at least about 3000 pli and a roll temperature of at least about 150° F. According to another embodiment, the calendering is instead or in addition calendering that includes calendering the coated substrate through a final nip comprising generally non-compliant rolls. The magnetic recording medium optionally defines a roughness average (Ra) of no more than about 6.3 nm. The magnetic recording medium optionally defines a cumulative write Class B reliability error rate of no more than about 3 write errors/MB over 300 hours of cycling, and/or a cumulative Class B read error rate of no more than about 100 read errors/GB over 300 hours of cycling. The magnetic recording medium optionally comprises Digital Linear Tape.

According to another embodiment of the invention, a method of producing a magnetic recording medium, such as medium 80, includes unwinding a substrate as at 56 in FIG. 2, back coating the unwound substrate as at 58, magnetically coating the unwound substrate as at 62, passing the unwound substrate only once through a calendering process comprising at least one nip having a generally compliant roll and a generally non-compliant roll, e.g., in the manner of calendering 66, winding the substrate as at 68, unwinding the substrate as at 70, passing the unwound substrate only once through a calendering process comprising at least one nip having opposed, generally non-compliant rolls to produce the magnetic recording medium, e.g., in the manner of calendering 72, and winding the substrate as at 74. The method further optionally includes slitting the substrate, as at 76.

Although specific embodiments have been illustrated and described herein for purposes of description, it will be appreciated by those of ordinary skill in the art that a wide variety of alternate and/or equivalent implementations calculated to achieve similar purposes may be substituted for the specific embodiments shown and described, without departing from the scope of the present invention. For example, calendering as described herein optionally includes one-nip calendering or multiple-nip calendering in the same calendering pass; one in-line or off-line calendering pass optionally includes one, two, three or more nips or nip stations. Multiple nips in a stack are also contemplated, for example one calendering pass may include seven rolls and five nips. According to another example, calendering passes optionally are combined into a lesser number of passes by including in the lesser number of passes an equivalent number of nips and/or nip stations. Thus, for example, a single calendering pass with eight nips optionally is used in place of four calendering passes, each with two nips. The number of nips and number of passes may vary, to suit a particular need or environment, for example. Different calendering speeds are contemplated for the calendering processes described herein, e.g., about 700 feet per minute, about 350 feet per minute, about 200 feet per minute, or other speeds. Processes or process steps defined herein need not occur in the exact order stated, but optionally occur in other orders or sequences. Pounds per linear inch (pli) values as described herein are taken relative to the width across the substrate or calendering nip, such that the values are scalable to a coating line of any given width, for example. Those with skill in the chemical, mechanical, electro-mechanical, electrical, and computer arts will readily appreciate that the present invention may be implemented in a very wide variety of embodiments. This application is intended to cover any adaptations or variations of the embodiments discussed herein.

What is claimed is:

1. A method for producing a magnetic recording medium, comprising:
providing a coated substrate adapted for recording, including applying a front coat to the substrate, the front coat having at least one layer including a magnetic component;
in-line calendering the coated substrate using opposed, generally non-compliant rolls; and
off-line calendering the coated substrate using opposed, generally non-compliant rolls.

2. The method of claim 1, wherein the front coat is a dual-layer front coat.

3. The method of claim 1, wherein the method comprises a single off-line calendering pass.

4. The method of claim 1, wherein the method comprises a single in-line calendering pass.

5. The method of claim 1, wherein the method comprises a single off-line calendering pass, the single off-line calendering pass occurring after the in-line calendering pass.

6. The method of claim 1, wherein the off-line calendering occurs at a nip pressure of at least about 2200 pli and a temperature of at least about 195° F.

7. The magnetic recording medium of claim 1, wherein the front coat comprises a non-magnetic lower layer and a magnetic upper layer.

8. The magnetic recording medium of claim 1, wherein the magnetic recording medium is in linear magnetic tape format.

9. A method for producing a magnetic recording medium, comprising:
providing a coated substrate adapted for recording, including applying a front coat to the substrate, the front coat having at least one layer including a magnetic component; and
calendering the coated substrate through a first calendering pass and a subsequent, second calendering pass, the second calendering pass using at least one nip formed by generally non-compliant rolls.

10. The method of claim 9, wherein the first calendering pass and the second calendering pass are both performed off-line, the first calendering pass using at least one nip formed by generally non-compliant rolls.

11. The method of claim 9, wherein the first calendering pass and the second calendering pass are performed in-line, the first calendering pass using at least one nip formed by generally non-compliant rolls.

12. The method of claim 9, wherein the first calendering pass is performed in-line and the second calendering pass is performed off-line, the first calendering pass using at least one nip formed by generally non-compliant rolls.

13. The method of claim 9, wherein the front coat has a thickness of less than about 2.5 microns prior to the second calendering pass.

14. The method of claim 9, wherein the nip of the second calendering pass is characterized by a nip pressure of at least about 700 pli and a roll temperature of at least about 100° F.

15. The method of claim 9, wherein the first calendering pass uses a single nip formed by generally non-compliant rolls.

16. The method of claim 9, wherein the second calendering pass uses a single nip formed by generally non-compliant rolls.

17. The method of claim 9, wherein at least one of the first and second calendering passes uses a plurality of nips formed by generally non-compliant rolls.

18. A magnetic recording medium produced by a method comprising:
providing a coated substrate adapted for recording, including applying a front coat to the substrate, the front coat having at least one layer including a magnetic component;
in-line calendering the coated substrate using opposed, generally non-compliant rolls; and
off-line calendering the coated substrate using opposed, generally non-compliant rolls.

19. The magnetic recording medium of claim 18, wherein the magnetic recording medium defines a roughness average (Rₐ) of no more than about 6.3 nm.

20. The magnetic recording medium of claim 19, wherein the magnetic recording medium comprises Digital Linear Tape.
